(19) United States
(12) Patent Application Publication
(10) Pub. No.: US 2026/0081501 A1
(43) Pub. Date: Mar. 19, 2026

(54) MOTOR AND BLOWING DEVICE

(71) Applicant: NIDEC CORPORATION, Kyoto (JP)

(72) Inventors: Nobuaki YASUMOTO, Kyoto (JP); Sakae NOGAMI, Kyoto (JP); Yuta YAMASAKI, Kyoto (JP); Toshihiro KAWAHARA, Kyoto (JP)

(21) Appl. No.: 19/396,754

(22) Filed: Nov. 21, 2025

Related U.S. Application Data
(63) Continuation of application No. PCT/JP2024/015115, filed on Apr. 16, 2024.

(30) Foreign Application Priority Data
May 26, 2023 (JP) 2023-086838

(51) Int. Cl. H02K 5/22; H02K 1/12

(52) U.S. Cl. CPC H02K 5/22; H02K 1/12; H02K 2211/03

(57) ABSTRACT

A motor includes a stator core, a coil portion, and a circuit board in a lidded cylindrical cover and covered with a covering portion that fills an inside of the cover. A guide portion of the cover is at an end portion of a board accommodation portion that surrounds and accommodates the circuit board. The guide portion accommodates and guides a lead wire to an outside in a radial direction. An end portion on an inside in the radial direction of a side wall portion is connected to the end portion on the one side in the axial direction of the board accommodation portion. An end portion on the one side in the axial direction of the side wall portion is farther to the one side in the axial direction than the end portion on the one side in the axial direction of the board accommodation portion.

### CROSS-REFERENCE TO RELATED APPLICATIONS

This application is a continuation of International Application No. PCT/JP2024/015115, filed on Apr. 16, 2024, and claims priority to Japanese Patent Application No. 2023-086838, filed in Japan on May 26, 2023, the entire contents of which are hereby incorporated herein by reference.

### 1. FIELD OF THE INVENTION

The present disclosure relates to motors and blowing devices.

### 2. BACKGROUND

There has been known a motor including a stator having waterproofing properties enhanced by surface covering. For example, a stator assembly component is disposed in a housing space of a cover. A circuit board is loosely inserted into an opening portion of the cover. The filling material is filled between the housing space of the cover and the stator assembly component from a gap between the cover and the circuit board and solidified to form the stator assembly component having a waterproof effect.

Incidentally, when the filling material before solidification is filled inside the cover, the filling material is likely to spill from the cover in the vicinity of a drawn out port of a lead wire that connects the stator to an external device or the like. When the filling material before solidification spills out, the filling amount after solidification decreases. Therefore, there is a possibility that water or the like may enter from the outside to deteriorate the electrical insulation of the stator.

### SUMMARY

An example embodiment of a motor of the present disclosure includes a rotor and a stator. The rotor is rotatable about a center axis extending in an axial direction. The stator includes a stator core including a magnetic body at which a coil portion is located. The stator further includes a circuit board, a cover, and a covering portion. The circuit board is located on one side in the axial direction from the stator core and electrically connected to a lead line drawn out from the coil portion. The cover has a lidded cylindrical shape extending in the axial direction and accommodates the stator core, the coil portion, and the circuit board. The covering portion is filled inside the cover and covers the stator core, the coil portion, and the circuit board. The cover includes a board accommodation portion and a guide portion. The board accommodation portion has a cylindrical shape that is open toward the one side in the axial direction and surrounds and accommodates the circuit board. The guide portion is located at an end portion on the one side in the axial direction of the board accommodation portion, accommodates a lead wire, and guides the lead wire radially outward. The lead wire is drawn out from the circuit board to an outside of the cover. The guide portion includes a bottom plate portion and a side wall portion. The bottom plate portion extends radially outward from the board accommodation portion when viewed from the axial direction. The side wall portion extends from an end portion of the bottom plate portion in a circumferential direction toward the one side in the axial direction. A radially inner end portion of the side wall portion is connected to the end portion on the one side in the axial direction of the board accommodation portion. An end portion on the one side in the axial direction of the side wall portion is located on the one side in the axial direction from the end portion on the one side in the axial direction of the board accommodation portion.

An example embodiment of a blowing device of the present disclosure includes the above-described motor and an impeller. The impeller is rotatable together with a rotor of the motor about a center axis extending in an axial direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic cross-sectional view illustrating a configuration example of a blowing device according to an example embodiment of the present disclosure.

FIG. 2 is a schematic plan view of the motor viewed from one side in an axial direction.

FIG. 3 is an enlarged cross-sectional view illustrating a configuration example of a guide portion according to an example embodiment of the present disclosure.

FIG. 4 is a perspective view of a guide portion according to an example embodiment of the present disclosure viewed from a radial direction.

### DETAILED DESCRIPTION

Hereinafter, example embodiments will be described with reference to the drawings.

In the present description, in a motor 100 of a blowing device 500, a direction parallel to a center axis CA is referred to as an “axial direction”. In the axial direction, an orientation from a stator core 11 described below toward a circuit board 15 described below is referred to as “one side in the axial direction Da”, and an orientation from the circuit board 15 toward the stator core 11 is referred to as “the other side in the axial direction Db”. Further, in the motor 100, a direction orthogonal to the center axis CA is referred to as a “radial direction”, and a direction of rotation about the center axis CA is referred to as a “circumferential direction”. In the radial direction, an orientation toward the center axis CA is referred to as “radially inward”, and an orientation away from the center axis CA is referred to as “radially outward”. In the following description, not only a “circumferential direction” in a cylindrical coordinate system (including an “axial direction”, a “radial direction”, and a “circumferential direction”) but also a “direction perpendicular to the axial direction and the radial direction” in an orthogonal coordinate system (including the “axial direction”, the “radial direction”, and a “direction perpendicular to the axial direction and the radial direction”) may be referred to as a “circumferential direction” in a pseudo manner.

Further, in the present description, an “annular shape” includes not only a shape continuously connected without breaks across the entire region in the circumferential direction about the center axis CA, but also a shape having one or more breaks in part of the entire region in the circumferential direction about the center axis CA. Further, an “annular shape” also includes a shape having a closed curve on a curved surface intersecting the center axis CA about the center axis CA.

Further, in a positional relationship between any one and any other of an azimuth, a line, and a plane, the term “parallel” includes not only a state in which the two elements do not intersect at all no matter how far each extends, but also a state in which the two are substantially parallel. Further, each of the terms “perpendicular” and “orthogonal” includes not only a state in which the two elements intersect each other at 90 degrees, but also a state in which the two elements are substantially perpendicular and a state in which the two elements are substantially orthogonal. That is, each of the terms “parallel”, “perpendicular”, and “orthogonal” includes a state in which the positional relationship between the two elements permits an angular deviation to an extent not departing from the spirit of the present disclosure.

Note that these terms are merely used for description and are not intended to limit actual positional relationships, directions, names, and the like.

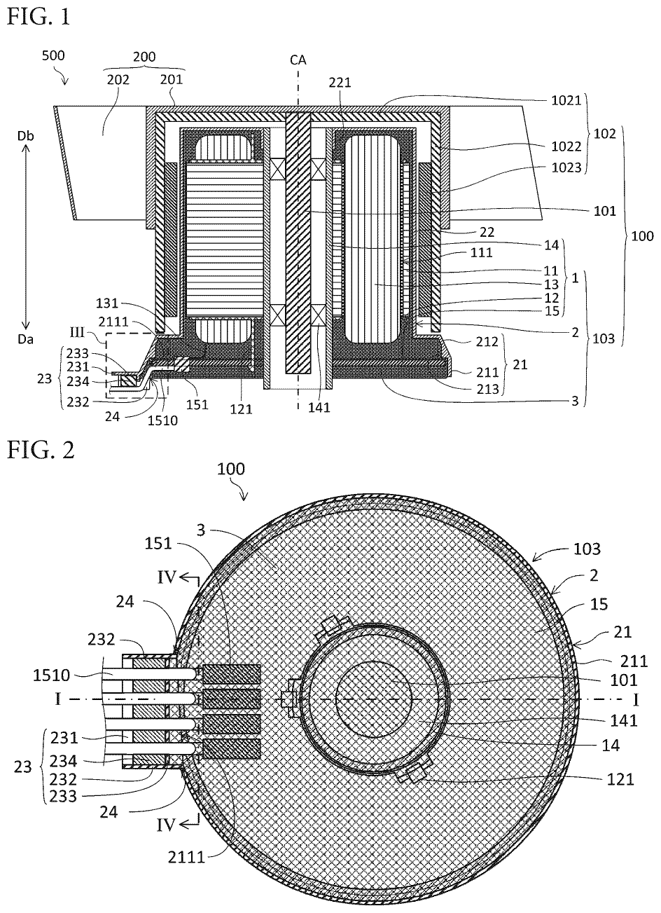

FIG. 1 is a schematic cross-sectional view illustrating a configuration example of a blowing device 500 according to an example embodiment. The cross-section of the motor 100 in FIG. 1 illustrates a cross-sectional structure of the motor 100 taken along a one dot chain line I-I in FIG. 2 to be described below.

As illustrated in FIG. 1, the blowing device 500 includes a motor 100 and an impeller 200. The motor 100 rotationally drives the impeller 200. The impeller 200 is rotatable together with a shaft 101 and a rotor 102 of the motor 100 around the center axis CA extending in the axial direction. The impeller 200 includes an impeller base 201 and a rotor blade 202. The impeller base 201 has a lidded cylindrical shape extending in the axial direction, and is attached to cover the rotor 102. The rotor blade 202 is arranged to extend radially outward from a radially outer side surface of the impeller base 201, and is arranged to extend in the axial direction. A plurality of rotor blades 202 are arranged in the circumferential direction. Note that the impeller base 201 may be omitted. That is, the rotor blade 202 may be disposed directly on the radially outer side surface of the rotor 102. According to the blowing device 500 of the present example embodiment, as will be described below, in the motor 100 of the blowing device 500, it is possible to improve electrical insulation of a stator 103 to be described below.

Next, a configuration example of the motor 100 will be described with reference to FIGS. 1 and 2. FIG. 2 is a schematic plan view of the motor 100 when viewed from the one side in the axial direction Da. In FIG. 2, a covering portion 3, which will be described below, is illustrated by translucent hatching.

As illustrated in FIGS. 1 and 2, the motor 100 includes the shaft 101, the rotor 102, and the stator 103.

The shaft 101 extends in the axial direction along the center axis CA and is rotatable around the center axis CA together with the impeller 200 and the rotor 102. That is, in the present example embodiment, the shaft 101 is a rotating shaft. However, the shaft 101 is not limited to this example, and may be a fixed shaft that is fixed together with the stator 103, or may be non-rotatable about the center axis CA. In the case of a fixed shaft, a bearing that rotatably supports the rotor 102 relative to the shaft 101 is disposed between the shaft 101 and the rotor 102.

The rotor 102 has a lidded cylindrical shape extending in the axial direction and is rotatable around the center axis CA. As described above, the motor 100 includes the rotor 102. In the present example embodiment, the rotor 102 surrounds a stator assembly 1, an assembly accommodation portion 22, and the like of the stator 103, which will be described below, and is fixed to an end portion on the other side in the axial direction of the shaft 101. As illustrated in FIG. 1, the rotor 102 includes a lid part 1021, a cylindrical portion 1022, and a magnet 1023. The lid part 1021 extends radially outward from the end portion on the other side in the axial direction of the shaft 101. The cylindrical portion 1022 extends to the one side in the axial direction Da from a radially outer end portion of the lid part 1021 and surrounds a part of the stator 103 (for example, the stator core 11, the coil portion 13, the assembly accommodation portion 22, and the like). The magnet 1023 is disposed on the radially inner side surface of the cylindrical portion 1022 and faces the stator assembly 1 and the assembly accommodation portion 22 in the radial direction. In the magnet 1023, a plurality of different magnetic poles are alternately arranged in the circumferential direction. Note that, in FIG. 1, the magnet 1023 is directly fixed to the inner side surface of the cylindrical portion 1022 in the radial direction. However, the configuration is not limited to this example, and the magnet 1023 may be fixed to the inner side surface of the cylindrical portion 1022 in the radial direction with a yoke, which is a magnetic body, extending in the axial direction and the circumferential direction interposed therebetween.

As illustrated in FIGS. 1 and 2, the stator 103 includes a stator assembly 1, a cover 2, and the covering portion 3.

The stator assembly 1 includes the stator core 11, an insulator 12, a plurality of the coil portions 13, a holding member 14, and the circuit board 15.

The stator core 11 has an annular shape surrounding the center axis CA. The stator 103 includes the stator core 11. The coil portion 13 is disposed in the stator core 11. The stator core 11 is a magnetic body and, in the present example embodiment, is a layered body in which electromagnetic steel plates each having a plate shape and extending in the radial direction are layered in the axial direction. The stator core 11 is fixed to an outer side surface of the holding member 14 in the radial direction and faces the magnet 1023 in the radial direction. Further, the stator core 11 includes a slot 111. A plurality of the slots 111 penetrate the stator core 11 in the axial direction and are arranged in the circumferential direction.

The insulator 12 has electrical insulation properties and is disposed on a surface of the stator core 11 (both end surfaces in the axial direction, inner side surfaces of the slots 111, and the like, in particular).

The coil portions 13 are respectively disposed in the slots 111. The stator 103 includes the coil portion 13. In other words, the coil portion 13 is a member in which a conductive wire (reference numeral omitted) is disposed in a coil shape on the stator core 11 via the insulator 12. Note that the conductive wire is, for example, an enamel-covered copper wire or a metal wire covered with an electrical insulating member, and is wound around the stator core 11 to form the coil portions 13. A plurality of coil portions 13 are arranged in the circumferential direction. When a drive current is supplied to each coil portion 13, the stator 103 is excited and drives the rotor 102.

The holding member 14 has a cylindrical shape surrounding the center axis CA and extending in the axial direction, and holds the stator core 11 on the outer side surface thereof in the radial direction. Further, a bearing 141 is disposed on an inner circumferential surface of the holding member 14, and the shaft 101 is inserted therethrough. In the present example embodiment, the holding member 14 rotatably supports the shaft 101 with the bearing 141 inserted therebetween. Note that the bearing 141 may be a rolling bearing such as a ball bearing, or may be a sliding bearing. Further, the number of bearings 141 is two in FIG. 1, but is not limited to this example, and may be one or three or more.

The circuit board 15 is disposed on the one side in the axial direction Da from the stator core 11, the coil portions 13, and the like, and is electrically connected to a lead line 131 drawn from the coil portion 13. The stator 103 includes the circuit board 15. Note that the lead line 131 is, for example, an end portion of the conductive wire constituting the coil portion 13. A drive circuit of the stator 103 and the like are mounted onto the circuit board 15. The circuit board 15 is supported by a support member 121. The support member 121 extends to the one side in the axial direction Da from the insulator 12 disposed at an end surface on the one side in the axial direction of the stator core 11.

The circuit board 15 includes a connector part 151. The connector part 151 is connected to at least one of connection wires of the lead line 131 and the lead wire 1510. The lead wire 1510 electrically connects the circuit board 15 and a device outside the motor 100. That is, the lead wire 1510 is a connection wire drawn out from the circuit board 15 to the outside of the motor 100 and the blowing device 500 via a guide portion 23 described below, and is connected to an external device or the like.

The cover 2 has a lidded cylindrical shape extending in the axial direction and is open toward the one side in the axial direction Da. The cover 2 accommodates the stator core 11, the coil portion 13, the circuit board 15, the covering portion 3, and the like. As described above, the stator 103 includes the cover 2. The configuration of the cover 2 will be described below.

The covering portion 3 is filled inside the cover 2 and covers the stator assembly 1 including the stator core 11, the coil portion 13, the circuit board 15, and the like. As described above, the stator 103 includes the covering portion 3. In the present example embodiment, the covering portion 3 is made of a thermosetting resin and has electrical insulation properties. For example, the covering portion 3 before curing is poured into the cover 2 to which the stator assembly 1 is attached under a vacuum or reduced pressure environment, and then cured by a firing treatment. The liquid surface of the covering portion 3 before curing rises in the one side in the axial direction Da at a contact part with an end portion on the one side in the axial direction of a board accommodation portion 21 of the cover 2, which will be described below, due to surface tension, that is, the liquid surface of the covering portion 3 is located on the one side in the axial direction Da from the end portion on the one side in the axial direction of the board accommodation portion 21. For this reason, an end portion on the one side in the axial direction of the cured covering portion 3 is located on the one side in the axial direction Da with respect to the end portion on the one side in the axial direction of the board accommodation portion 21 of the cover 2.

The covering portion 3 is disposed between the stator assembly 1 and the cover 2. With this configuration, a surface of the stator assembly 1 can be covered with the cover 2 and the covering portion 3. Accordingly, it is possible to prevent dust and liquid such as water from entering the stator 103. Therefore, the electrical insulation of the surface of the stator assembly 1 can be improved.

The covering portion 3 further covers the surface of the circuit board 15 (and the connector part 151, the circuit, the device, the wiring, and the like mounted on the circuit board 15). In this manner, the adhesion of dust and liquid such as water to the circuit board 15 can be prevented by the cover of the covering portion 3. Accordingly, the electrical insulation properties of the surface of the circuit board 15 can be improved.

Next, a configuration example of the cover 2 will be described with reference to FIGS. 1 and 2. As illustrated in FIGS. 1 and 2, the cover 2 includes the board accommodation portion 21, the assembly accommodation portion 22, the guide portion 23, and the fillet portion 24.

The board accommodation portion 21 has a cylindrical shape extending in the axial direction and is open toward the one side in the axial direction Da. As described above, the cover 2 includes the board accommodation portion 21. The board accommodation portion 21 is arranged to surround and accommodate the circuit board 15.

The board accommodation portion 21 includes a cylindrical portion 211, a frustum cylindrical portion 212, and a stepped portion 213.

The cylindrical portion 211 has a cylindrical shape extending in the axial direction at the end portion on the one side in the axial direction of the board accommodation portion 21, and is connected to the guide portion 23. As described above, the board accommodation portion 21 includes the cylindrical portion 211. In the present example embodiment, the cylindrical portion 211 surrounds and accommodates the circuit board 15.

The cylindrical portion 211 includes a recessed portion 2111. In other words, the board accommodation portion 21 includes the recessed portion 2111. The recessed portion 2111 is recessed from an end portion on the one side in the axial direction of the cylindrical portion 211 to the other side in the axial direction Db at a connection portion between the cylindrical portion 211 and the guide portion 23, and is open to both side surfaces of the cylindrical portion 211 in the radial direction.

The frustum cylindrical portion 212 has a truncated conical lidded cylindrical shape and is connected to an end portion on the other side in the axial direction of the cylindrical portion 211. The cylinder portion of the frustum cylindrical portion 212 extends from the end portion on the other side in the axial direction of the cylindrical portion 211 to the other side in the axial direction Db. The inner diameter and the outer diameter of the cylinder portion decrease toward the other side in the axial direction Db. The lid portion of the frustum cylindrical portion 212 expands radially inward from an end portion on the other side in the axial direction of the cylinder portion. In the present example embodiment, the lid portion has an annular shape surrounding the stator assembly 1 when viewed from the axial direction.

The stepped portion 213 protrudes radially inward from an inner circumferential surface (i.e., a radially inner side surface) of the board accommodation portion 21, and extends in the circumferential direction. The cover 2 includes the stepped portion 213. In the present example embodiment, the stepped portion 213 protrudes radially inward from the inner circumferential surface (radially inner side surface) of the frustum cylindrical portion 212. The stepped portion 213 may have an annular shape surrounding the center axis CA, or may have a configuration in which a plurality of arc-shaped step pieces extending in the circumferential direction are arranged in the circumferential direction.

The stepped portion 213 is disposed on the other side in the axial direction Db with respect to the circuit board 15. An end portion on the one side in the axial direction of the stepped portion 213 faces an end surface on the other side in the axial direction of the circuit board 15 in the axial direction. In this manner, the stepped portion 213 can suppress the movement of the circuit board 15 to the other side in the axial direction Db. In addition, the internal volume of the cover 2 can be reduced by the arrangement of the stepped portion 213. Therefore, since the amount of the covering portion 3 can be reduced, the manufacturing cost of the motor 100 can be reduced, and the productivity of the motor 100 can be improved.

The present disclosure is not limited to the above-described example, and the cylindrical portion 211 may be omitted. In this case, the cylinder portion of the frustum cylindrical portion 212 surrounds the circuit board 15. In addition, the fillet portion 24 and the recessed portion 2111 are disposed at an end portion on the one side in the axial direction of the frustum cylindrical portion 212, and the guide portion 23 is connected to the end portion on the one side in the axial direction of the frustum cylindrical portion 212.

In this manner, the inner diameter of at least a part of the board accommodation portion 21 in the axial direction may decrease toward the other side in the axial direction Db. This reduces the volume of the board accommodation portion 21 as compared to a configuration in which the inner diameter of the board accommodation portion 21 is constant when viewed from the axial direction. Therefore, since the amount of the covering portion 3 can be reduced, the manufacturing cost of the motor 100 can be reduced, and the productivity of the motor 100 can be improved.

However, this example does not exclude a configuration in which the inner diameter of the board accommodation portion 21 does not decrease toward the other side in the axial direction Db. For example, the frustum cylindrical portion 212 may be omitted. That is, the inner diameter of the board accommodation portion 21 may be constant in the axial direction. In this case, the stepped portion 213 protrudes radially inward from the inner circumferential surface (radially inner side surface) of the cylindrical portion 211.

The assembly accommodation portion 22 has a lidded cylindrical shape and accommodates the stator assembly 1. The cylinder portion of the assembly accommodation portion 22 has a cylindrical shape extending from the opening of the lid portion of the frustum cylindrical portion 212 to the other side in the axial direction Db and surrounds the stator assembly 1. The lid portion of the assembly accommodation portion 22 extends radially inward from the end portion on the other side in the axial direction of the cylinder portion. In the present example embodiment, the lid portion has an annular shape surrounding the holding member 14 when viewed from the axial direction. The assembly accommodation portion 22 includes an inner cylindrical portion 221. The inner cylindrical portion 221 has a cylindrical shape extending from the radially inner side surface of the lid portion of the assembly accommodation portion 22 to the one side in the axial direction Da. An end portion on the other side in the axial direction of the holding member 14 is inserted into the inner cylindrical portion 221. The end portion on the other side in the axial direction of the holding member 14 is fixed to the inner cylindrical portion 221.

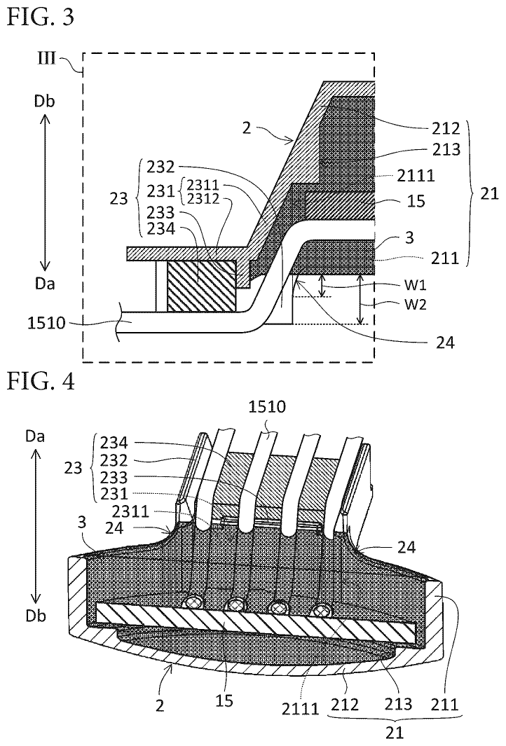

Next, a configuration example of the guide portion 23 will be described with reference to FIGS. 1 to 4. FIG. 3 is an enlarged cross-sectional view illustrating a configuration example of the guide portion 23. FIG. 4 is a perspective view of the guide portion 23 when viewed from the radial direction. FIG. 3 is an enlarged cross-sectional view of a portion III surrounded by a broken line in FIG. 1. FIG. 4 illustrates a portion of the motor 100 on the radially outer side with respect to a virtual plane along a one dot chain line IV-IV in FIG. 2 and parallel to the axial direction. Further, the one side in the axial direction Da and the other side in the axial direction Db in FIG. 4 are opposite to those in FIGS. 1 to 3.

The guide portion 23 is disposed at the end portion on the one side in the axial direction of the board accommodation portion 21, accommodates the lead wire 1510, which is drawn out of the cover 2 from the circuit board 15, and guides the lead wire radially outward. As described above, the cover 2 includes the guide portion 23. In the present example embodiment, the guide portion 23 is disposed at the same circumferential position as the recessed portion 2111 at an end portion on the one side in the axial direction of the cylindrical portion 211 (see FIG. 2).

The guide portion 23 includes a bottom plate portion 231, a pair of side wall portions 232, a protruding wall portion 233, and an elastic portion 234.

The bottom plate portion 231 extends radially outward from the board accommodation portion 21 when viewed from the axial direction. As described above, the guide portion 23 includes the bottom plate portion 231. For example, as illustrated in FIG. 2, the bottom plate portion 231 extends radially outward from an inner side surface (that is, a bottom surface) of the recessed portion 2111 of the cylindrical portion 211 facing the one side in the axial direction Da when viewed from the axial direction.

In the present example embodiment, as illustrated in FIG. 3, the bottom plate portion 231 includes an inclined part 2311 and an extending part 2312. The inclined part 2311 extends radially outward from the bottom surface of the recessed portion 2111 toward the one side in the axial direction Da. The extending part 2312 extends radially outward from a radially outer end portion of the inclined part 2311. In addition, the inclined part 2311 and the extending part 2312 extend in the circumferential direction (in other words, a direction perpendicular to the axial direction and the radial direction). The present disclosure is not limited to the above example, and the inclined part 2311 may be omitted. For example, the extending part 2312 may extend radially outward from the bottom surface of the recessed portion 2111.

The pair of side wall portions 232 are arranged in the circumferential direction (in other words, a direction perpendicular to the axial direction and the radial direction). As described above, the guide portion 23 includes the side wall portion 232. The side wall portion 232 extends from an end portion of the bottom plate portion 231 in the circumferential direction (in other words, a direction perpendicular to the axial direction and the radial direction) to the one side in the axial direction Da and expands in the radial direction. For example, in the present example embodiment, as illustrated in FIGS. 2 to 4, one side wall portion 232 extends from end portions on one side of the inclined part 2311 and the extending part 2312 in the circumferential direction to the one side in the axial direction Da and expands in the radial direction. The other side wall portion 232 extends from end portions on the other side of the inclined part 2311 and the extending part 2312 in the circumferential direction to the one side in the axial direction Da and expands in the radial direction.

A radially inner end portion of the side wall portion 232 is connected to the end portion on the one side in the axial direction of the board accommodation portion 21, and in the present example embodiment, is connected to the end portion on the one side in the axial direction of the cylindrical portion 211. An end portion on the one side in the axial direction of the side wall portion 232 is located on the one side in the axial direction Da with respect to the end portion on the one side in the axial direction of the board accommodation portion 21, and in particular, is located on the one side in the axial direction Da with respect to the end portion on the one side in the axial direction of the cylindrical portion 211.

In this manner, when the inside of the cover 2 is filled with the covering portion 3 before curing, it is possible to prevent the covering portion 3 before curing from spilling from the connection portion between the board accommodation portion 21 and the side wall portion 232 of the guide portion 23. In addition, even if the covering portion 3 spills, the amount thereof is small, and thus it is not necessary to wipe off the spilled covering portion 3 before curing, and the filling can be performed without paying attention to the spilling. Therefore, the production efficiency in the filling step of the covering portion 3 before curing can be improved. Since the connection portion can be sufficiently covered with the covering portion 3 without lowering the filling speed of the covering portion 3 before curing, the infiltration of water, dust or the like from the connection portion can be prevented. Therefore, the electrical insulation of the stator 103 can be improved.

Here, preferably, the end portion on the one side in the axial direction of the board accommodation portion 21 is located on the one side in the axial direction Da with respect to an end surface on the one side in the axial direction of the bottom plate portion 231, and for example, is located on the one side in the axial direction Da with respect to an end surface on the one side in the axial direction of the extending part 2312. In this manner, the connection portion between the radially inner end portion of the side wall portion 232 and the end portion on the one side in the axial direction of the board accommodation portion 21 can be disposed on the one side in the axial direction Da with respect to the end surface on the one side in the axial direction of the bottom plate portion 231 (particularly, the extending part 2312). Therefore, the covering portion 3 before curing is less likely to spill off at the connection portion.

The protruding wall portion 233 protrudes to the one side in the axial direction Da from the bottom plate portion 231 and extends in the circumferential direction (in other words, a direction perpendicular to the axial direction and the radial direction). The guide portion 23 includes the protruding wall portion 233. An end portion on the one side in the axial direction of the protruding wall portion 233 is located on the one side in the axial direction Da with respect to an end surface on the one side in the axial direction of the covering portion 3. In the present example embodiment, as illustrated in FIG. 4, both end portions of the protruding wall portion 233 in the circumferential direction are spaced apart from the side wall portion 232. However, the present disclosure is not limited to this example. At least one of the end portions of the protruding wall portion 233 in the circumferential direction may be connected to the side wall portion 232.

The elastic portion 234 is disposed at the end surface on the one side in the axial direction of the bottom plate portion 231. As described above, the guide portion 23 includes the elastic portion 234. Specifically, the elastic portion 234 is disposed at the end surface on the one side in the axial direction of the extending part 2312. At least one of the end portions of the elastic portion 234 in the circumferential direction (in other words, a direction perpendicular to the axial direction and the radial direction) may be spaced apart from the side wall portion 232 or may be in contact with the side wall portion 232.

With this configuration, the lead wire 1510 can be stably drawn out by bringing the lead wire 1510 to be drawn out to the outside into contact with an end surface on the one side in the axial direction of the elastic portion 234. Further, the radially outward flow of the covering portion 3 before curing through the inside of the guide portion 23 can be blocked by the elastic portion 234. Therefore, it is possible to prevent the covering portion 3 before curing from flowing out to the outside through the inside of the guide portion 23.

A material having high elasticity is used for the elastic portion 234, and for example, a porous elastic body such as natural rubber, synthetic rubber, or urethane sponge can be adopted.

Further, in the present example embodiment, the elastic portion 234 is disposed radially outward of the protruding wall portion 233 and is in contact with the radially outer side surface of the protruding wall portion 233. With this configuration, the arrangement position of the elastic portion 234 in the radial direction can be easily determined. Further, the radially outward flow of the covering portion 3 before curing through the inside of the guide portion 23 can be blocked by the elastic portion 234. Therefore, it is possible to more effectively prevent the covering portion 3 before curing from flowing out to the outside through the inside of the guide portion 23. However, this example does not exclude a configuration in which the elastic portion 234 is disposed radially inward of the protruding wall portion 233. For example, the elastic portion 234 may be in contact with the radially inner side surface of the protruding wall portion 233.

Next, a configuration example of the fillet portion 24 will be described with reference to FIGS. 1 to 4. The fillet portion 24 connects an end portion of a radially inner end portion of the guide portion 23 in the circumferential direction (in other words, a direction perpendicular to both the axial direction and the radial direction) and the end portion on the one side in the axial direction of the board accommodation portion 21. In the present example embodiment, the fillet portion 24 connects a radially inner end portion of a side wall portion 232, which will be described below, of the guide portion 23 and the end portion on the one side in the axial direction of the board accommodation portion 21. The cover 2 includes the fillet portion 24. More specifically, the fillet portion 24 connects a radially inner end portion of the side wall portion 232 and the end portion on the one side in the axial direction of the cylindrical portion 211 of the board accommodation portion 21. In other words, the fillet portion 24 is disposed at a corner formed by the radially inner end portion of the side wall portion 232 of the guide portion 23 and the end portion on the one side in the axial direction of the cylindrical portion 211 of the board accommodation portion 21. The fillet portion 24 is a wall for rounding or eliminating a corner formed by the radially inner end portion of the side wall portion 232 and the end portion on the one side in the axial direction of the cylindrical portion 211 of the board accommodation portion 21. The fillet portion 24 extends in the axial direction and the circumferential direction. A circumferential end portion of the fillet portion 24 is connected to a radially inner end portion of the side wall portion 232. An end portion on the other side in the axial direction of the fillet portion 24 is connected to the end portion on the one side in the axial direction of the cylindrical portion 211.

At the corner of the connection portion between the radially inner end portion of the side wall portion 232 and the end portion on the one side in the axial direction of (the cylindrical portion 211 of) the board accommodation portion 21, when the inside of the cover 2 is filled with the covering portion 3 before curing, the covering portion 3 before curing is likely to spill off due to the action of surface tension. Therefore, by disposing the fillet portion 24 at this corner, it is possible to prevent the covering portion 3 before curing from spilling from the connection portion between the two components (that is, the above-described corner portion).

The outer shape of the fillet portion 24 when viewed from the radial direction is a tapered shape extending toward the side wall portion 232 side in the circumferential direction toward the one side in the axial direction Da. The tapered shape may be a curved shape recessed toward the other side in the axial direction Db and the side wall portion 232 side in the circumferential direction as illustrated in FIG. 4, or may be a linear shape. That is, depending on the arrangement of the fillet portion 24, the corner formed by the radially inner end portion of the side wall portion 232 and the end portion on the one side in the axial direction of the cylindrical portion 211 of the board accommodation portion 21 may be rounded as illustrated in FIG. 4, or may be chamfered.

Preferably, the axial size W1 of the fillet portion 24 is greater than or equal to one third of the axial width W2 of the side wall portion 232 of the guide portion 23. Further, the axial size W1 is equal to or less than the axial width W2 of the side wall portion 232 of the guide portion 23 (see FIG. 3). In this manner, it is possible to more reliably prevent the covering portion 3 before curing from spilling from the connection portion between the two components (that is, the corner portion formed by the radially inner end portion of the side wall portion 232 and the end portion on the one side in the axial direction of the cylindrical portion 211).

When the axial size W1 is less than one third of the axial width W2, the covering portion 3 before curing may overflow to the outside over an end portion on the one side in the axial direction (in other words, the tapered portion) of the fillet portion 24.

In addition, in a case where the axial size W1 exceeds the axial width W2, the end portion on the one side in the axial direction of the fillet portion 24 protrudes to the one side in the axial direction Da beyond the end portion on the one side in the axial direction of the side wall portion 232. Therefore, for example, when the lead wire 1510 is drawn out to the outside, the end portion on the one side in the axial direction of the fillet portion 24 (that is, the protruding portion) becomes an obstacle, and there is a possibility that workability is lowered.

Example embodiments of the present disclosure have been described above. Note that the scope of the present disclosure is not limited to the example embodiments described above. The present disclosure can be implemented by making various modifications to the above-described example embodiments without departing from the spirit of the disclosure. In addition, the matters described in the above example embodiments can be combined together as desired and appropriate, as long as there is no inconsistency.

The following provides a comprehensive description of the example embodiments described above.

For example, a motor according to an example embodiment disclosed in the present description is configured (first configuration) to include a rotor rotatable about a center axis extending in an axial direction, and a stator including a stator core being a magnetic body at which a coil portion is located, wherein the stator further includes a circuit board provided on one side in the axial direction from the stator core and electrically connected to a lead line drawn out from the coil portion; a cover having a lidded cylindrical shape extending in the axial direction, the cover to accommodate the stator core, the coil portion, and the circuit board, and a covering portion inside the cover, the covering portion to cover the stator core, the coil portion, and the circuit board, the cover includes a board accommodation portion having a cylindrical shape that is open toward the one side in the axial direction, the board accommodation portion to surround and accommodate the circuit board, and a guide portion provided at an end portion on the one side in the axial direction of the board accommodation portion, the guide portion to accommodate a lead wire drawn out from the circuit board to an outside of the cover and guide the lead wire radially outward, the guide portion includes a bottom plate portion extending radially outward from the board accommodation portion when viewed from the axial direction, and a side wall portion extending from an end portion of the bottom plate portion in a circumferential direction toward the one side in the axial direction, a radially inner end portion of the side wall portion is connected to the end portion on the one side in the axial direction of the board accommodation portion, and an end portion on the one side in the axial direction of the side wall portion is located on the one side in the axial direction from the end portion on the one side in the axial direction of the board accommodation portion.

The motor of the first configuration may be configured (second configuration) such that the cover further includes a fillet portion to connect the radially inner end portion of the side wall portion and the end portion on the one side in the axial direction of the board accommodation portion.

The motor of the second configuration may be configured (third configuration) such that an axial size of the fillet portion is equal to or greater than one third of an axial width of the side wall portion.

The motor of any one of the first to third configurations may be configured (fourth configuration) such that the guide portion further includes an elastic portion located at an end surface on the one side in the axial direction of the bottom plate portion.

The motor of the fourth configuration may be configured (fifth configuration) such that the guide portion further includes a protruding wall portion protruding from the bottom plate portion toward the one side in the axial direction and extending in the circumferential direction (in other words, a direction perpendicular to the axial direction and the radial direction), and the elastic portion is located radially outward of the protruding wall portion.

The motor of any one of the first to fifth configurations may be configured (sixth configuration) such that the board accommodation portion includes a cylindrical portion extending in the axial direction at the end portion on the one side in the axial direction of the board accommodation portion and connected to the guide portion, and a recessed portion recessed from an end portion on the one side in the axial direction of the cylindrical portion to the other side in the axial direction, the recessed portion being open to both side surfaces of the cylindrical portion in the radial direction at a connection portion between the cylindrical portion and the guide portion, the bottom plate portion extends radially outward from an inner side surface of the recessed portion opposing the one side in the axial direction when viewed from the axial direction, and the end portion on the one side in the axial direction of the board accommodation portion is located on the one side in the axial direction from an end surface on the one side in the axial direction of the bottom plate portion.

The motor of any one of the first to sixth configurations may be configured (seventh configuration) such that the cover further includes a stepped portion protruding radially inward from an inner circumferential surface of the board accommodation portion and extending in the circumferential direction, and an end portion on the one side in the axial direction of the stepped portion opposes an end surface on the other side in the axial direction of the circuit board in the axial direction.

The motor of any one of the first to seventh configurations may be configured (eighth configuration) such that an inner diameter of at least a portion of the board accommodation portion in the axial direction decreases toward the other side in the axial direction.

A blowing device disclosed in an example embodiment of the present description is configured (ninth configuration) to include the motor of any one of the first to eighth configurations, and an impeller rotatable together with a rotor of the motor about a center axis extending in an axial direction.

Example embodiments of the present disclosure are useful for devices that cover a stator assembly of a motor with a covering portion.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a center axis extending in an axial direction; and
a stator including a stator core including a magnetic body at which a coil portion is located; wherein
the stator further includes:
a circuit board provided on one side in the axial direction from the stator core and electrically connected to a lead line drawn out from the coil portion;
a cover having a lidded cylindrical shape extending in the axial direction, the cover to accommodate the stator core, the coil portion, and the circuit board; and
a covering portion inside the cover, the covering portion to cover the stator core, the coil portion, and the circuit board;
the cover includes:
a board accommodation portion having a cylindrical shape that is open toward the one side in the axial direction, the board accommodation portion to surround and accommodate the circuit board; and
a guide portion provided at an end portion on the one side in the axial direction of the board accommodation portion, the guide portion to accommodate a lead wire drawn out from the circuit board to an outside of the cover and guide the lead wire radially outward;
the guide portion includes:
a bottom plate portion extending radially outward from the board accommodation portion when viewed from the axial direction; and
a side wall portion extending from an end portion of the bottom plate portion in a circumferential direction toward the one side in the axial direction;
a radially inner end portion of the side wall portion is connected to the end portion on the one side in the axial direction of the board accommodation portion; and
an end portion on the one side in the axial direction of the side wall portion is located on the one side in the axial direction from the end portion on the one side in the axial direction of the board accommodation portion.

2. The motor according to claim 1, wherein
the cover further includes a fillet portion to connect the radially inner end portion of the side wall portion and the end portion on the one side in the axial direction of the board accommodation portion.

3. The motor according to claim 2, wherein
an axial size of the fillet portion is equal to or greater than about one third of an axial width of the side wall portion.

4. The motor according to claim 1, wherein
the guide portion further includes an elastic portion located at an end surface on the one side in the axial direction of the bottom plate portion.

5. The motor according to claim 4, wherein
the guide portion further includes a protruding wall portion protruding from the bottom plate portion toward the one side in the axial direction and extending in the circumferential direction; and
the elastic portion is located radially outward of the protruding wall portion.

6. The motor according to claim 1, wherein
the board accommodation portion includes:
a cylindrical portion extending in the axial direction at the end portion on the one side in the axial direction of the board accommodation portion and connected to the guide portion; and
a recessed portion recessed from an end portion on the one side in the axial direction of the cylindrical portion to another side in the axial direction, the recessed portion being open to two side surfaces of the cylindrical portion in the radial direction at a connection portion between the cylindrical portion and the guide portion;
the bottom plate portion extends radially outward from an inner side surface of the recessed portion opposing the one side in the axial direction when viewed from the axial direction; and
the end portion on the one side in the axial direction of the board accommodation portion is located on the one side in the axial direction from an end surface on the one side in the axial direction of the bottom plate portion.

7. The motor according to claim 1, wherein
the cover further includes a stepped portion protruding radially inward from an inner circumferential surface of the board accommodation portion and extending in the circumferential direction; and
an end portion on the one side in the axial direction of the stepped portion opposes an end surface on the other side in the axial direction of the circuit board in the axial direction.

8. The motor according to claim 1, wherein
an inner diameter of at least a portion of the board accommodation portion in the axial direction decreases toward the other side in the axial direction.

9. A blowing device comprising:
the motor according to claim 1; and
an impeller rotatable together with a rotor of the motor about a center axis extending in an axial direction.
